(19) United States
(12) Patent Application Publication
(10) Pub. No.: US 2003/0196889 A1
(43) Pub. Date: Oct. 23, 2003

(54) Porous film and method for producing the same

(76) Inventors: Karl Pflanz, Reinhausen (DE); Eric Jallerat, Ville d'Avray (FR); Hans Beer, Waake-Bosinghausen (DE); Timo Klewitz, Hannover (DE)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/417,439

(22) Filed: Apr. 16, 2003

(30) Foreign Application Priority Data
Apr. 18, 2002 (DE) DE 102 17 415.6

(51) Int. Cl. H05F 3/00; B01D 39/00

(52) U.S. Cl. 204/165; 210/500.22; 210/500.29

(57) ABSTRACT

Cellulose nitrate membranes useful in immuno-assay diagnostic tests are rendered hydrophilic by exposure to a low energy plasma.

Pursuant to 35 USC 119, the priority of DE 102 17 415.6 filed Apr. 18, 2002 is claimed.

### BACKGROUND OF THE INVENTION

Protein-impregnated porous films of pure cellulose nitrate (“CN”) or of CN-containing cellulose esters such as cellulose diacetate, cellulose triacetate or cellulose semi-esters are known and widely used in immuno-assays as a substrate in diagnostic dip-strip tests using a lateral flow format. See, for example, commonly assigned U.S. Pat. No. 5,628,960. The '960 patent discloses the fabrication of a supported isotropic microporous CN membrane containing a small amount of cellulose acetate (“CA”) by phase inversion.

Such supported CN membranes have proven themselves in lateral flow tests since they have a high non-specific protein-binding capacity and can be produced with equal-sized pores in the range of 0.01 to 20 μm. But a problem with such membranes is that they are not wettable by water and so a surfactant must be added to render them sufficiently hydrophilic to impregnate them with proteins, which are typically present in an aqueous solution. In the case of CN membranes prepared by the method described in the '960 patent, surfactants must be added without delay to the coating solution, at the latest before the drying step. The surfactants used for such treatment are conventionally anionic surfactants, such as Sodium Lauryl Sulfate (SLS) or Sodium Lauryl Benzyl Sulfonate (SLBS), both of which are amphiphilic. But because of the amphiphilic nature of the surfactant, competing bidirectional reactions occur in the protein solutions that are applied to the membrane, as well as in the membrane's surface. Such competing reactions diminish the membrane's protein-binding capacity and interfere with the antibody/antigen binding, thereby reducing the accuracy and sensitivity of the immuno-assay test.

The use of low energy plasma to modify the surface characteristics of chemically stable textiles, plastics and membranes is known. See, for example, U.S. Pat. Nos. 4,457,145 and 6,074,534, EP 0 695 622 B1 and 188 J. Memb. Sci. 97 (2001). However, the use of such a treatment on fragile, chemically less stable CN membranes has not been reported, probably due to concerns about the possible degradation or destruction of the membrane.

It is therefore a primary object of the present invention to render a porous CN membrane hydrophilic without the use of surfactants to achieve a chemically stable membrane that is capable of very accurate and sensitive tests in immuno-assay diagnostic tests.

### BRIEF SUMMARY OF THE INVENTION

In a first aspect, the invention comprises the provision of a hydrophilic CN membrane without treatment by a surfactant, namely, by exposure to a low energy plasma discharge. In a second aspect the invention comprises a process for rendering the surface of a CN membrane hydrophilic. Both aspects of the invention provide a CN membrane useful in diagnostic tests such as immuno-chromatographic lateral flow tests that has the following advantages:

the membrane is hydrophilized on a long-term basis without the use of a surfactant;

the membrane allows quick penetration of liquids;

the lateral migration rate of liquids along the membrane is increased;

in comparison to a conventionally treated hydrophilized membrane, test indicators such as bands or lines of bound proteins are improved both as to sharpness and color intensity; and

the chemical stability of the membrane is improved.

### BRIEF DESCRIPTION OF THE DRAWINGS

FIG. 1 is a photo of a CN membrane rendered hydrophilic by treatment with a surfactant and impregnated with one line each aqueous solutions of the proteins of gamma-globulin (top) and bovine serum albumin (bottom).

FIG. 2 is a photo of a CN membrane rendered hydrophilic by the inventive process and impregnated with the same proteins in the same order as the membrane shown in FIG. 1.

FIG. 3 is a Scanning Electron Microscope (SEM) photograph of a CN membrane rendered hydrophilic by treatment with a surfactant.

FIG. 4 is an SEM photograph of a CN membrane rendered hydrophilic by the inventive process.

### DETAILED DESCRIPTION OF THE PREFERRED EMBODIMENTS

The typical immuno-chromographic lateral flow test is conducted simply by dipping an indicator reagent-impregnated test strip in the sample to be assayed. After a few minutes, the results of the test are visible on the test strip. In a first step, a specific antibody line and a control line is laid upon a CN test strip. The sharpness and color intensity of these lines, especially the specific antibody line, is critical for the evaluation of the results of the test. In the case of qualitative assays a high degree of reproducibility is required. The sharpness and color intensity of these lines depends upon the laminar structure of the CN membrane, its surface characteristics (a spontaneously wettable, open structure) and the degree of protein-to-film irreversible binding.

To the start end of the test strip, a reservoir of an additional specific antibody is applied in a mixture containing an unspecified, buffered protein solution. The specific antibody, as a rule, is labeled with colored latex or gold as a conjugate, in order to enhance the visual evaluation of the immuno-reaction. The antigen to be identified (the analyte) is brought into contact with the start end of the dry test strip, where it reacts with a specific, labeled antibody (AK1) in the reservoir and is subsequently conveyed laterally along the strip by virtue of the penetrative flow arising from the wicking action of the buffered protein, until it reaches the reaction zone of the specific antibody line (AK2), onto which it binds. The labeled specific antibody, in this operation, is not bound as a non-specific on the surface of the CN substrate, since this is already saturated with an unspecified protein. By means of the specific binding of the labeled antigen or antigen complex (AK1) onto the existing antibody line (AK2), there is created a positive indicator line, which, in the presence of a gold-colored latex suspension, can be readily seen. The control line binds nonspecific excess antibody complexes and functions principally as confirmation of correct execution of the tests.

The term “gas plasma” as used herein means at least one gas in an excited and/or ionized state. Plasmas may be created in a vacuum chamber, not only in the presence of one gas at low pressure but even in the presence of a gas mixture, by the application of a high frequency electromagnetic field which is discharged in the vacuum chamber to excite and/or ionize the gas(es), whereupon free radicals may be formed and/or UV radiation may be generated. The excited gas reacts with the surface of the layer in the uppermost mono-molecular lamina of the CN membrane. Depending upon the gas composition and the energy applied, in addition to rendering the membrane hydrophilic, different effects can be achieved, from merely scouring or cleaning the membrane's surface to removing one or more layers. In the case of asymmetric membranes which typically have small pores at or near the surface and larger pores below the surface, the removal of at least one surface layer has the added effect of rendering the membrane's pore structure more uniform by virtue of the removal of the layer(s) containing the smaller pores. When the gas(es) include oxygen, oxygen free radicals and ions react with the non-polar surface of the CN membrane and form hydrophilic groups, which of course causes the exposed layer to become wettable. A particularly preferred gas mixture comprises argon and oxygen, preferably in a 80:20 vol % ratio. Rather surprisingly, it has been observed that such treatment not only does not diminish the CN or cellulose mixed-ester membrane, but actually increases its chemical stability.

### EXAMPLES

Isotropic CN membranes containing a small amount of CA were fabricated by phase inversion by casting a dope comprising a commercially available polymer blend of CN (5-10%) and CA (<2%) in a solvent mixture of methyl acetate (40-60%), alcohols (30-50%), and water onto a foil support in a drawing machine while evaporating the volatile components of the solvent mixture.

This membrane batch is then either left untreated (Test 2), impregnated with a surfactant of <0.5% SLBS) (Test 1), or treated with a low energy plasma (Test 3).

Low energy plasma discharge treatment was conducted in a vacuum chamber in conventional manner, in accordance with the state of the technology, either continuously on membrane rolls or batchwise on membrane loops, preferably in an 80:20 vol % argon:oxygen atmosphere, at pressures of from about 0.1 to about 0.5 mbar, at 100 to 500 Watts for 5 seconds to 5 minutes.

The plasma power input and the dwell time in the plasma discharge may be set so as to not destroy the laminar structure of the CN membrane. For removing membrane layers, for example, a membrane 170 μm thick was exposed for 2 minutes in the 80:20 argon/oxygen plasma with a plasma power input of 400 W. Under these conditions, surface layers were removed from the membrane, reducing its thickness to 145-150 μm. The quality and the intensity of the treatment can affect the wettability, the resulting thickness of the layer and the penetration time of liquids into and along the surface of the membrane.

In Table 1, the characteristics of the CN/CA membranes of Tests 1-3 are compared.

TABLE 1

| | | Test 2 | Test 3 |
|---|---|---|---|
| | | Surfactant- | Surfactant- |
| | Test 1 | free, | free, |
| | Containing | non-plasma | plasma |
| Characteristic | surfactant | treated | treated |
| Layer Thickness | 170 | 170 | 145-150 |
| (microns) | | | |
| Wettability | 2.3 | >300 | 0.5-1.8 |
| with 20% NaCl | | | |
| Solution, | | | |
| measured as | | | |
| penetration | | | |
| time | | | |
| (sec/10 μL) | | | |
| Migration Time | 73-76 | not | 48-55 |
| transverse to | | applicable | |
| pulling | | | |
| direction | | | |
| sec/40 mm | | | |
| Chemical | 9-14 | 80 | 0.4-7.2 |
| Stability per | | | |
| Bergmann-Jung | | | |
| test at 132° C. | | | |
| for 2 hr | | | |
| (mL 0.01 N | | | |
| NaOH/g film) | | | |

The wettability test was measured as penetration time in seconds, in which, subsequent to the application of a 10 μL drop of a 20% NaCl aqueous solution to the surface of the CN membrane by an Eppendorf pipette, no liquid could be detected on the membrane's surface. As seen in Table 1, Test 3 showed the shortest penetration time; when measured five months later the penetration time remained the same.

The migration time determination was carried out on 10×41 mm test strips which were stamped out transverse to the layer roll (i.e., axially), since the diagnostic tests were also run in the same direction. A 1 mm deep reservoir of the test equipment was filled with Phenol Red acid-base indicator solution, the membrane samples were partially immersed therein at the narrow side and a stop watch was started upon the immersion. When the penetration front reached the upper end of the sample strip, the stop watch was stopped and the elapsed time was recorded. Test 3 showed a clearly faster penetration time than did reference Test 1. (The migration test is not applicable to the non-wettable, surfactant-free and non-plasma treated membrane of Test 2.)

The chemical stability of each CN/CA membrane was determined in accordance with the Bergmann-Jung procedure, which basically involves heating the membrane to the point of chemical degradation, thereby causing the release of nitrous oxide gas. The Bergmann-Jung procedure was conducted in a heated splitting apparatus equipped with a thermostat and each sample container was provided with a water-filled gas trap for the evolved gas. Dry membrane samples weighing 1.00 g were heated for one hour at 130° C., resulting in the evolution of nitrous oxide gas into the gas traps. The samples and the content of the gas traps were subsequently rinsed with water into a beaker and titrated with 0.01 N KOH, using Congo Red as an indicator to measure various aspects of surface energy, summarized in Table 2 below.

The surface energy was measured on a Type K12 tensionmeter with K121 software (Krüss) in accord with the Washburn method and the evaluation was made using the Owens/Wendt/Rabel/Kälble method. The sorption behavior of solvents of different polarity was was used to determine surface energy. After the contact with the test liquid, the weight increase per unit time was measured. Test liquids were n-heptane (which was used to determine the capillarity constant), di-iodomethane and a 20:80 wt % ethanol water mixture.

The supported 35×45 mm membrane test strips were always so gripped in the probe holder (Krüss-Wilhelmy Sample Holder Model No. FQ12) that the shorter side faced the liquid medium and the under edge was aligned parallel to the liquid surface. The tests were conducted on three test strips which were stamped out adjacent the layer sample to be tested.

In the first step, the time-dependent sorption measure for the determination of the capillarity (geometric factor c) was conducted. The medium was n-heptane and the software program employed was “Laboratory Desktop.” The Add-in K12 Contact Angle Module was started and carried out as directed by the operating instructions. After the conclusion of the measurement, the measured sample was discarded. The measured capillarity was accepted as a parameter for the determination of the contact angle for the following measurements. The capillarity was determined as a typical material constant and is expressed by the following relationship:

c=½(Π²r⁵n²ₖ) where

c=material constant, i.e., geometric factor c;

r=capillary radius; and

nₖ=number of capillaries.

In the second step, sorption measurements were carried out in the same manner with two additional media (di-iodomethane and a 20:80 wt % ethanol:water mixture) to determine the contact angle. From the measurement of the capillarity and contact angle the software program computes the surface energy of the membrane samples in accord with the following equation:

$$cos θ = \frac{{m}^{2} n}{t {ρ}^{2} σ c} where$$

θ=contact angle between the sample surface and the liquid;

t=time;

η=viscosity of the liquid;

ρ=density of the liquid;

σ=surface tension of the liquid; and

c=material constant, i.e., geometric factor c.

TABLE 2

| | Test 2 | Test 3 |
|---|---|---|
| | Surfactant-free, | Surfactant-free, |
| Type of Surface | non-plasma | plasma |
| Energy | treated | treated |
| Total Energy | 24-28 mN/m | 25-30 mN/m |
| Dispersive | 24-28 mN/m | 22-25 mN/m |
| Portion | | |
| Polar Portion | 0-1 mN/m | 2-7 mN/m |

As is apparent from the data shown in Table 2, the plasma-treated films exhibit a substantial increase in the polar portion of surface energy, which correlates well with favorable wettability.

In order to evaluate the suitability of the inventive membranes for use in an immuno-assay, the following test procedure was employed, which approximates an actual application.

Identical volumes of the proteins bovine serum albumin (BSA) and gamma-globulin aqueous solutions, each containing 1 mg active/mL in a 0.15 M Phosphate Buffered Solution (PBS) [8.00 g NaCl, 0.20 g KCl, 0.44 g Na₂HPO₄ and 0.24 g KH₂PO₄ adjusted to pH 7.4 with HCl, balance deionized water to one liter] were applied onto surfactant-impregnated and plasma-treated membranes in test lines 1 cm from the longitudinal edge. Subsequently, the lines were made visible by direct coloration by the proteins adsorbed on the film by means of 0.2 wt % Ponceau S in a 5 wt % acetic acid solution. Following this, a qualitative, visual evaluation of the test lines in regard to intensity, sharpness and shape was made. The membrane samples were then dried for 30 minutes at 40° C. in a drying chamber.

The dried membrane samples were again treated with the Ponceau S solution, resulting in the coloration of the entire surface of the membranes, including the lines of test proteins were colored. Decoloration of the portion of the membranes not having protein test lines was done by shaking the film twice every 5 minutes in 5 wt % acetic acid. Subsequently, the decolored membranes were dried for 30 minutes at 40° C. in a drying chamber.

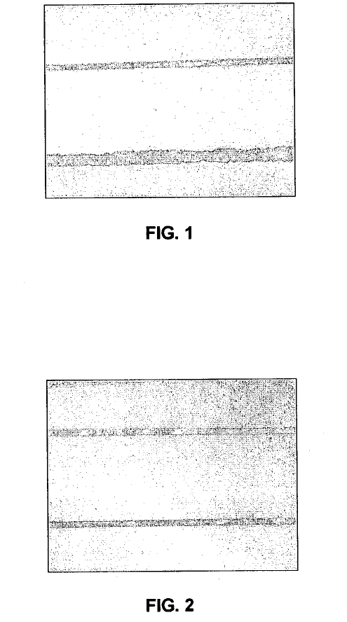

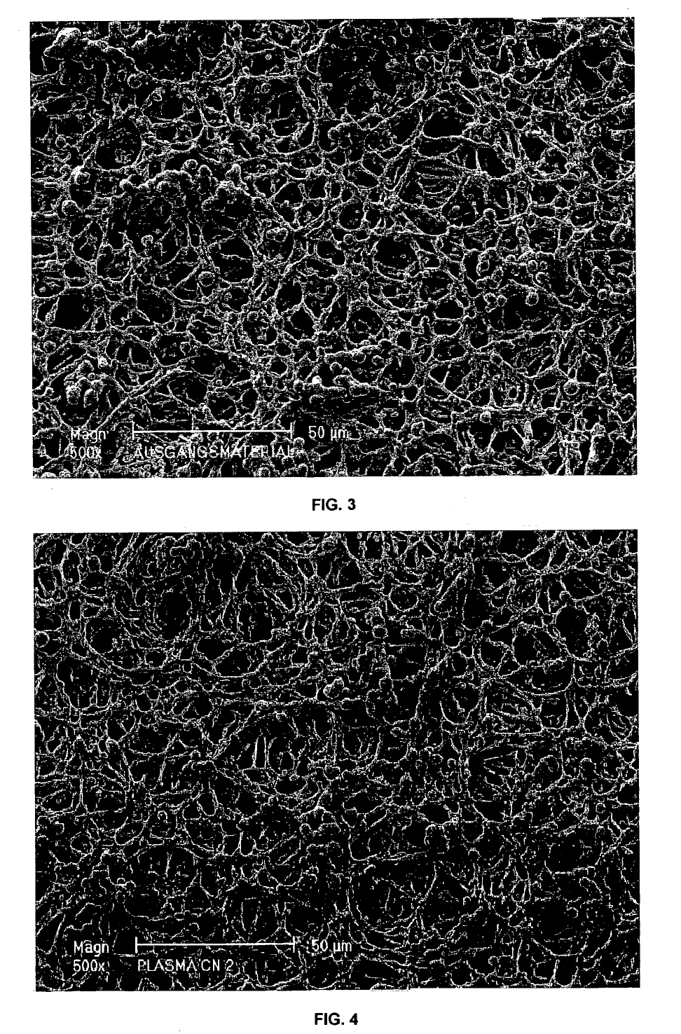

In FIGS. 1 and 2, the standardized line formation is shown. The plasma-treated membrane of FIG. 2 exhibits much sharper lines, especially the BSA line, as compared to the surfactant-impregnated membrane of FIG. 1. The SEM photograph of FIG. 3 is of a surfactant-impregnated CN/CA membrane with pore sizes about 10 μm in diameter. The SEM photograph of FIG. 4 is of a CN/CA membrane without surfactant and treated with plasma in accordance with the invention with pore sizes of about 10 μm.

A comparison of FIG. 4 to an SEM photo of the same membrane taken before plasma treatment (not shown) showed no significant structural differences between the treated and the non-treated membrane.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A porous membrane comprising cellulose nitrate rendered hydrophilic by exposure to a low energy plasma.

2. The membrane of claim 1 on a support.

3. The membrane of claim 2 wherein said support is a foil.

4. The membrane of claim 1 characterized by a polar surface energy exceeding 2 mN/m.

5. The membrane of claim 1 characterized by a liquid penetration rate of less than 10 seconds for a 10 μl drop of a 20 wt % aqueous NaCl solution.

6. The membrane of claim 1 having an average pore diameter of from 0.01 to 20 μm.

7. The membrane of any of claims 1 to 6 employed as a substrate in a diagnostic test.

8. The membrane of claim 10 wherein said diagnostic test is an immuno-chromatographic lateral flow test.

9. A process for the manufacture of a porous hydrophilic membrane comprising exposing a porous membrane comprising cellulose nitrate to a low energy plasma in an ionizable atmosphere.

10. The process of claim 9 wherein said atmosphere comprises oxygen.

11. The process of claim 10 wherein said atmosphere includes an inert gas.

12. The process of claim 11 wherein said inert gas is argon.

13. The process of claim 12 wherein said atmosphere comprises about 80 vol % argon and about 20 vol % oxygen.

14. The process of claim 13 wherein said plasma discharge is provided by an energy input of from about 100 to about 500 Watts for a dwell time of from about 5 seconds to about 5 minutes.

15. The process of claim 14 wherein the energy input is about 400 Watts and the dwell time is about 2 minutes so as to cause the removal of at least a surface layer of said membrane.
